(19) United States
(12) Patent Application Publication
(10) Pub. No.: US 2019/0101924 A1
(43) Pub. Date: Apr. 4, 2019

(54) Anomaly Detection Systems and Methods for Autonomous Vehicles

(71) Applicant: Uber Technologies, Inc., San Francisco, CA (US)

(72) Inventors: Alexander David Styler, Pittsburgh, PA (US); Anh Tuan Hoang, San Francisco, CA (US)

(21) Appl. No.: 15/793,291

(22) Filed: Oct. 25, 2017

Related U.S. Application Data
(60) Provisional application No. 62/567,533, filed on Oct. 3, 2017.

(51) Int. Cl. G05D 1/02; G05D 1/00; B60W 30/095; G08G 1/16

(52) U.S. Cl. CPC G05D 1/0214; G05D 1/0088; B60W 30/0956; G05D 2201/0213; G08G 1/166; B60W 2550/10; G08G 1/167

(57) ABSTRACT

Systems and methods for anomaly detection are provided. In one example embodiment, a computer-implemented method includes obtaining, by a computing system including one or more computing devices, state data indicative of one or more states of one or more objects that are within a surrounding environment of an autonomous vehicle. The method includes determining, by the computing system, an existence of an anomaly within the surrounding environment of the autonomous vehicle based at least in part on the state data indicative of the one or more states of the one or more objects within the surrounding environment of the autonomous vehicle. The method includes determining, by the computing system, a motion plan for the autonomous vehicle based at least in part on the existence of the anomaly within the surrounding environment of the autonomous vehicle.

### PRIORITY CLAIM

The present application is based on and claims priority to U.S. Provisional Application 62/567,533 having a filing date of Oct. 3, 2017, which is incorporated by reference herein.

### FIELD

The present disclosure relates generally to detecting an anomaly within the surrounding environment of an autonomous vehicle.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for anomaly detection. The method includes obtaining, by a computing system including one or more computing devices, state data indicative of one or more states of one or more objects that are within a surrounding environment of an autonomous vehicle. The method includes determining, by the computing system, an existence of an anomaly within the surrounding environment of the autonomous vehicle based at least in part on the state data indicative of the one or more states of the one or more objects within the surrounding environment of the autonomous vehicle. The method includes determining, by the computing system, a motion plan for the autonomous vehicle based at least in part on the existence of the anomaly within the surrounding environment of the autonomous vehicle.

Another example aspect of the present disclosure is directed to a computing system for anomaly detection. The system includes one or more processors and one or more tangible, non-transitory, computer readable media that collectively store instructions that when executed by the one or more processors cause the computing system to perform operations. The operations include obtaining state data indicative of one or more states of one or more objects that are within a surrounding environment of an autonomous vehicle. The operations include determining an existence of an anomaly within the surrounding environment of the autonomous vehicle based at least in part on the state data indicative of the one or more states of the one or more objects within the surrounding environment of the autonomous vehicle. The operations include determining a motion plan for the autonomous vehicle based at least in part on the existence of the anomaly within the surrounding environment of the autonomous vehicle. The operations include causing the autonomous vehicle to initiate travel in accordance with the motion plan.

Yet another example aspect of the present disclosure is directed to an autonomous vehicle. The autonomous vehicle includes one or more processors and one or more tangible, non-transitory, computer readable media that collectively store instructions that when executed by the one or more processors cause the autonomous vehicle to perform operations. The operations include obtaining state data indicative of one or more states of one or more objects that are within a surrounding environment of an autonomous vehicle. The operations include determining an existence of an anomaly within the surrounding environment of the autonomous vehicle based at least in part on the state data indicative of the one or more states of the one or more objects within the surrounding environment of the autonomous vehicle. The operations include generating data indicative of the existence of the anomaly. The operations include determining the motion plan for the autonomous vehicle based at least in part on the data indicative of the existence of the anomaly.

Other example aspects of the present disclosure are directed to systems, methods, vehicles, apparatuses, tangible, non-transitory computer-readable media, and memory devices for detecting anomalies and controlling autonomous vehicles with respect to the same.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system overview according to example embodiments of the present disclosure;

FIG. 2 depicts a first example environment with an example object according to example embodiments of the present disclosure;

FIG. 3 depicts a diagram of an example implementation of a model according to example embodiments of the present disclosure

FIG. 4 depicts a second example environment with an example object according to example embodiments of the present disclosure;

FIG. 5 depicts an example scene of a surrounding environment according to example embodiments of the present disclosure;

FIG. 6 depicts a flow diagram of an example method for anomaly detection according to example embodiments of the present disclosure;

FIG. 7 depicts a flow diagram of another example method for anomaly detection according to example embodiments of the present disclosure; and

FIG. 8 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to detecting anomalies within the surrounding environment of an autonomous vehicle. For instance, an autonomous vehicle can be a vehicle that can drive, navigate, operate, etc. with little to no human input. The autonomous vehicle can perform various actions to autonomously navigate through its surroundings and with respect to the objects (e.g., vehicles, pedestrians, bicycles, etc.) included therein. For example, the autonomous vehicle can use sensor data acquired onboard the autonomous vehicle to help generate state data that describes current and/or past states of one or more objects within the surrounding environment of the vehicle. The autonomous vehicle can predict the motion of these object(s) based on these state(s). The systems and methods of the present disclosure herein can enable an autonomous vehicle to detect whether the motion of an object is anomalous (e.g., nonconforming to the expected actions of the object and/or the surrounding environment). For example, the autonomous vehicle can compare the actual motion trajectory of an object (e.g., as observed by the vehicle) with the predicted motion of the object (e.g., as predicted by the vehicle) to determine whether the object's motion is an anomaly, such that the predicted motion is no longer accurate. Additionally, or alternatively, the autonomous vehicle can detect whether the entire scene of the surrounding environment is anomalous. For example, the autonomous vehicle can identify that there is a larger crowd within the surrounding environment at a location that is atypical for the presence of a larger crowd (e.g., within an intersection). The autonomous vehicle can plan its motion with respect to the anomaly, for example, to proceed cautiously, decelerate to stopped position, etc. In this way, the autonomous vehicle can improve its motion planning to account for anomalies within the vehicle's surrounding environment, thereby enhancing vehicle/passenger/object safety and vehicle efficiency.

More particularly, an autonomous vehicle can be a ground-based autonomous vehicle (e.g., car, truck, bus, etc.) or another type of vehicle (e.g., aerial vehicle) that can operate with minimal and/or no interaction from a human operator. The autonomous vehicle can include a vehicle computing system located onboard the autonomous vehicle to help control the autonomous vehicle. The vehicle computing system can be located onboard the autonomous vehicle, in that the vehicle computing system can be located on or within the autonomous vehicle. The vehicle computing system can include one or more sensors (e.g., cameras, Light Detection and Ranging (LIDAR), Radio Detection and Ranging (RADAR), etc.), an autonomy computing system (e.g., for determining autonomous navigation), one or more vehicle control systems (e.g., for controlling braking, steering, powertrain), etc. The sensor(s) can gather sensor data (e.g., image data, RADAR data, LIDAR data, etc.) associated with the surrounding environment of the vehicle. For example, the sensor data can include LIDAR point cloud(s) and/or other data associated with one or more object(s) that are proximate to the autonomous vehicle (e.g., within a field of view of the sensor(s)) and/or one or more geographic characteristics of the geographic area (e.g., curbs, lane markings, sidewalks, etc.). The object(s) can include, for example, other vehicles, pedestrians, bicycles, etc. The object(s) can be static (e.g., not in motion) or dynamic (e.g., actors in motion). The sensor data can be indicative of characteristics (e.g., locations) associated with the object(s) at one or more times. The sensor(s) can provide such sensor data to the vehicle's autonomy computing system.

In addition to the sensor data, the autonomy computing system can retrieve or otherwise obtain other types of data associated with the surrounding environment in which the objects (and/or the autonomous vehicle) are located. For example, the autonomy computing system can obtain map data that provides detailed information about the surrounding environment of the autonomous vehicle. The map data can provide information regarding: the identity and location of different roadways, road segments, buildings, sidewalks, or other items; the location and directions of traffic lanes (e.g., the boundaries, location, direction, etc. of a parking lane, a turning lane, a bicycle lane, or other lanes within a particular travel way); traffic control data (e.g., the location and instructions of signage, traffic lights, laws/rules, or other traffic control devices); the location of obstructions (e.g., roadwork, accident, etc.); data indicative of events (e.g., scheduled concerts, parades, etc.); and/or any other map data that provides information that assists the vehicle computing system in comprehending and perceiving its surrounding environment and its relationship thereto.

The autonomy computing system can be a computing system that includes various sub-systems that cooperate to perceive the surrounding environment of the autonomous vehicle and determine a motion plan for controlling the motion of the autonomous vehicle. For example, the autonomy computing system can include a perception system, a prediction system, and a motion planning system.

The perception system can be configured to perceive one or more objects within the surrounding environment of the autonomous vehicle. For instance, the perception system can process the sensor data from the sensor(s) to detect the one or more objects that are proximate to the autonomous vehicle as well as state data associated therewith. The state data can be indicative of one or more states (e.g., current or past state(s)) of one or more objects that are within the surrounding environment of the autonomous vehicle. For example, the state data for each object can describe (e.g., at a given time, time period, etc.) an estimate of the object's current and/or past location (also referred to as position), current and/or past speed/velocity, current and/or past acceleration, current and/or past heading, current and/or past orientation, size/footprint, class (e.g., vehicle class vs. pedestrian class vs. bicycle class), the uncertainties associated therewith, and/or other state information.

The prediction system can be configured to predict a motion of the object(s) within the surrounding environment of the autonomous vehicle. For instance, the prediction system can create prediction data associated with the one or more the objects. The prediction data can be indicative of one or more predicted future locations of each respective object. The prediction data can indicate a predicted path associated with each object. The predicted path can be indicative of a predicted motion trajectory along which the respective object is predicted to travel over time. The prediction data can indicative the speed at which the object is predicted to travel along the predicted path and/or a timing associated therewith.

The vehicle computing system (e.g., the prediction system, an anomaly detector) can also be configured to detect an anomaly within the surrounding environment of the autonomous vehicle. An anomaly can be associated with at least one object that is not acting in conformance with its expected/predicted behavior and/or motion. Additionally, or alternatively, an anomaly can be associated with a scene of the surrounding environment (e.g., a snap shot of the surrounding environment at a particular time and/or time period) that is not in conformance with expectations for that scene. For example, there may be a plurality of objects within the scene of the surrounding environment (e.g., within an intersection). In some implementations, the behaviors/movements of the plurality of objects can be indicative of an anomaly within the scene (e.g., a large group of jaywalkers). In some implementations, the plurality of objects may themselves be behaving in a non-anomalous manner, however their presence within the scene may be indicative of an anomaly. For example, the presence of a large crowd spread throughout an intersection that does not typically have large crowds can be indicative of an anomalous scene. Accordingly, the vehicle computing system can determine (e.g., while in motion, on-line, etc.) that an object (e.g., actor), a plurality of objects, and/or a scene is moving and/or otherwise behaving in a manner that cannot accurately be predicted with the vehicle's current software.

The vehicle computing system can determine the existence of the anomaly in a variety of manners. For instance, the vehicle computing system can obtain state data indicative of one or more states of one or more objects that are within the surrounding environment of the autonomous vehicle. The vehicle computing system can determine an existence of an anomaly within the surrounding environment of the autonomous vehicle based at least in part on the state data. In some implementations, the vehicle computing system can employ a rule(s)-based algorithm to determine the existence of an anomaly. For example, the vehicle computing system can determine an actual motion trajectory of at least one object and a predicted motion trajectory of the at least one object (e.g., based at least in part on the state data). The vehicle computing system can access rule(s) that consider where the at least one object is at a current time relative to where the vehicle computing system (e.g., the prediction system) predicted the at least one object would be t seconds ago. The vehicle computing system can employ this recall technique to compare the at least one object's actual motion trajectory with the predicted motion trajectory to determine the overlap between past prediction locations and current/future locations. In the event that there is a deviation (e.g., above a particular threshold) by the actual object motion trajectory from the predicted object motion trajectory, the vehicle computing system can determine that an anomaly exists (e.g., with the at least one object's motion).

By way of example, the vehicle computing system (e.g., the prediction system) can perceive another vehicle travelling on a bridge ahead of the autonomous vehicle. The vehicle computing system can predict that the other vehicle will continue to travel straight across the bridge. However, the vehicle may instead perform a u-turn in the middle of the bridge. The vehicle computing system can compare the actual motion trajectory (e.g., the u-turn) to a previously predicted motion trajectory (e.g., straight path) to determine that an anomaly exists with respect to the object's motion, and, thus, that the object's predicted trajectory is not accurate.

In some implementations, the vehicle computing system can determine the existence of an anomaly within the surrounding environment of the autonomous vehicle based at least in part on a model. For instance, the prediction system can include, employ, and/or otherwise leverage a model such as a machine-learned model (e.g., a machine-learned anomaly detection model). The machine-learned model can be or can otherwise include one or more various model(s) such as, for example, neural networks (e.g., deep neural networks), or other multi-layer non-linear models. Neural networks can include convolutional neural networks, recurrent neural networks (e.g., long short-term memory recurrent neural networks), feed-forward neural networks, and/or other forms of neural networks. For instance, supervised training techniques can be performed to train the model to determine the existence of an anomaly within the surrounding environment of an autonomous vehicle (e.g., using labeled state data, prediction data, etc. with known instances of anomalies). In some implementations, the training data can be based at least in part on the anomalies identified using conventional rules, as described herein, to help train a machine-learned model for anomaly detection. The training data can be used to train a machine-learned anomaly prediction model offline, which can then be used as a an additional, or alternative, approach for predicting anomalies (e.g., with less latency).

The vehicle computing system can input data into the machine-learned model and receive an output. For instance, the vehicle computing system (e.g., the prediction system) can obtain data indicative of the machine-learned model from an accessible memory onboard the autonomous vehicle and/or from a memory that is remote from the vehicle (e.g., via a wireless network). The vehicle computing system can input data (e.g., state date, prediction data, etc.) into the machine-learned model. The machine-learned model can process the data to detect an anomaly (e.g., associated with an individual object and/or associated with a scene) and provide an output indicative of whether an anomaly exists. In some implementations, the machine-learned model can include a classifier (e.g., binary anomaly classifier) that provides an output indicative of the existence of an anomaly in a binary manner. In some implementations, the machine-learned model can include a regression model (e.g., linear/logistic regression, etc.) that provides an output indicative of a value in a continuous value range. This type of model (e.g., a continuous anomaly regression) can indicate, for example, the likelihood that an anomaly exists (e.g., as a percentage, decimal, etc.). The likelihood can be based at least in part on a confidence level of the model as it processes the input data.

By way of example, the vehicle computing system (e.g., the prediction system) can perceive another vehicle travelling on a one-way road ahead of the autonomous vehicle. The vehicle computing system can predict that the other vehicle will stop within the travel way based at least in part on the state data associated with that vehicle (e.g., indicating that the other vehicle's speed is decreasing over time). However, once the vehicle is stopped, the vehicle may begin to travel in a reverse direction, against the intended direction of the road, in order to parallel park into a parking space. In such a case, the vehicle computing system can input the state data indicative of the vehicle's location, speed, heading, etc. at various times, a predicted motion trajectory, and/or other data into the machine-learned model. The machine-learned model can process such data and provide an output indicating that the object's motion is an anomaly and/or the likelihood that the object's motion is an anomaly.

In some implementations, the vehicle computing system can determine the existence of an anomaly based at least in part on one or more anomaly categories. For instance, categories (e.g., definitions) can be generated for different types of anomalies (e.g., u-turns, parallel parking, wrong way down one-way street, large unexpected crowds, etc.). As one or more objects and/or other aspects of a surrounding environment are observed and analyzed, the vehicle computing system can determine if they fit into one or more of the different categories. If so, an anomaly of the particular type defined by the category can be predicted. For example, the vehicle computing system can determine an actual motion trajectory (e.g., 180 degree left hand turn) of an object (e.g., another vehicle) based at least in part on the state data indicative of the one or more states of the object. The vehicle computing system can access data indicative of the one or more anomaly categories from an accessible memory located onboard the vehicle and/or remote from the vehicle. The vehicle computing system can determine the existence of an anomaly (e.g., a u-turn maneuver) based at least in part on the actual motion trajectory of the object fitting into at least one of the one or more anomaly categories (e.g., a u-turn category).

Additionally, or alternatively, the vehicle computing system can determine that a scene of its surrounding environment is anomalous (e.g., rather than only a specific actor). A scene can be indicative of one or more objects, their motion, geographic features, etc. of a surrounding environment during a particular time (e.g., a point in time, during a time period, etc.). The vehicle computing system can obtain state data indicative of the state(s) of the plurality of objects within the scene (e.g., the 360 degree view of the autonomous vehicle) as well as other data (e.g., map data) associated with the surrounding environment. The vehicle computing system can determine the existence of an anomaly in the scene based at least in part on such data. A scene can be labelled as anomalous using, for example, any of the techniques described herein. By way of example, the vehicle computing system could identify scenes such as large unexpected crowds as anomalous based at least in part on a rule(s)-based algorithm, machine-learned model, categories, etc.

The vehicle computing system (e.g., the prediction system) can generate prediction data indicative of the existence of the anomaly. In some implementations, the prediction data can indicate that the predicted motion trajectories of one or more objects are not accurate (e.g., due to the anomaly). In some implementations, the prediction data can indicate that an object and/or the scene is an anomaly within the vehicle's surrounding environment. Additionally, or alternatively, the prediction data can be indicative of a likelihood that the anomaly exists (e.g., as outputted from the machine-learned model). The vehicle computing system (e.g., the prediction system) can provide the prediction data to the motion planning system of the autonomous vehicle.

The motion planning system can determine a motion plan for the autonomous vehicle. A motion plan can include vehicle actions (e.g., planned vehicle trajectories, speed(s), acceleration(s), other actions, etc.) with respect to the objects proximate to the vehicle as well as the objects' predicted movements. For instance, the motion planning system can implement an optimization algorithm that considers cost data associated with a vehicle action as well as other objective functions (e.g., cost functions based on speed limits, traffic lights, etc.), if any, to determine optimized variables that make up the motion plan. The motion planning system can determine that the vehicle can perform a certain action (e.g., pass an object) without increasing the potential risk to the vehicle and/or violating any traffic laws (e.g., speed limits, lane boundaries, signage).

In the event that an anomaly is detected within the vehicle's surrounding environment, the vehicle computing system can determine a motion plan for the autonomous vehicle based at least in part the existence of the anomaly. The vehicle computing system (e.g., the motion planning system) can weigh the anomaly during its cost data analysis as it determines an optimized trajectory through the surrounding environment. In some implementations, the existence of the anomaly may not ultimately change the motion of the autonomous vehicle. In some implementations, the motion plan may define the vehicle's motion such that the autonomous vehicle avoids the anomalous object(s), reduces speed to give more leeway around anomalous object(s), proceeds cautiously within an anomalous scene, performs a stopping action, etc.

The vehicle computing system can cause the autonomous vehicle to initiate travel in accordance with the motion plan. The motion plan can be provided to a vehicle controller that is configured to implement the motion plan. For example, the vehicle controller can translate the motion plan into instructions for the vehicle control system (e.g., acceleration control, brake control, steering control, etc.). In some implementations, the vehicle computing system can request vehicle assistance (e.g., from a service provider) to address an anomaly.

In some implementations, data associated with the detected anomalies can be used for testing/training of a vehicle computing system. For instance, the vehicle computing system can store data associated with the anomaly in a memory onboard the autonomous vehicle and/or remote from the autonomous vehicle. Such data can be included in a testing dataset that can be used for testing a vehicle autonomy system and its associated software. For example, the testing dataset can include the state data and/or prediction data associated with anomalous objects, the state data and/or prediction data associated with non-anomalous objects, and/or a combination thereof. This can allow the autonomy system software to be tested offline based on testing data exclusively indicative of anomalies, free of anomalies, and/or indicative of both anomalies and non-anomalies. Accordingly, the autonomy system software can be developed to better predict the motion of objects (e.g., anomalous objects) as well as improve the planning of autonomous vehicle motion (e.g., with respect to anomalous objects).

The systems and methods described herein provide a number of technical effects and benefits. For instance, the present disclosure provides systems and methods for improved predictions of the anomalies within the surrounding environment of the autonomous vehicles and improved vehicle control. The improved ability to detect anomalies (e.g., anomalous objects, anomalous scenes, etc.) can enable improved motion planning and/or other control of the autonomous vehicle based on such anomalies, thereby further enhancing passenger safety and vehicle efficiency. Thus, the present disclosure improves the operation of an autonomous vehicle computing system and the autonomous vehicle it controls. In addition, the present disclosure provides a particular solution to the problem of anomaly detection and provides a particular way (e.g., use of specific rules, machine-learned models, categories, etc.) to achieve the desired outcome. The present disclosure also provides additional technical effects and benefits, including, for example, enhancing passenger/vehicle safety and improving vehicle efficiency by reducing collisions (e.g., potentially caused by anomalies).

The systems and methods of the present disclosure also provide an improvement to vehicle computing technology, such as autonomous vehicle computing technology. For instance, the systems and methods enable the vehicle technology to determine whether an object or scene is behaving in an anomalous manner. In particular, a computing system (e.g., vehicle computing system) can obtain state data indicative of one or more states of one or more objects that are within a surrounding environment of an autonomous vehicle. The computing system can determine an existence of an anomaly within the surrounding environment of the autonomous vehicle based at least in part on the state data indicative of the one or more states of the one or more objects within the surrounding environment of the autonomous vehicle. The computing system can determine a motion plan for the autonomous vehicle based at least in part on the existence of the anomaly within the surrounding environment of the autonomous vehicle. By identifying anomalies in object behavior/movement, the computing system can plan vehicle motion based on the informed knowledge that predicted object motion trajectories may not perform well for a particular object. This may be used to alter autonomous vehicle behavior near these objects and/or through anomalous scenes to be more conservative, or, longer-term, initiate a remote signal request for service or assistance at the autonomous vehicle.

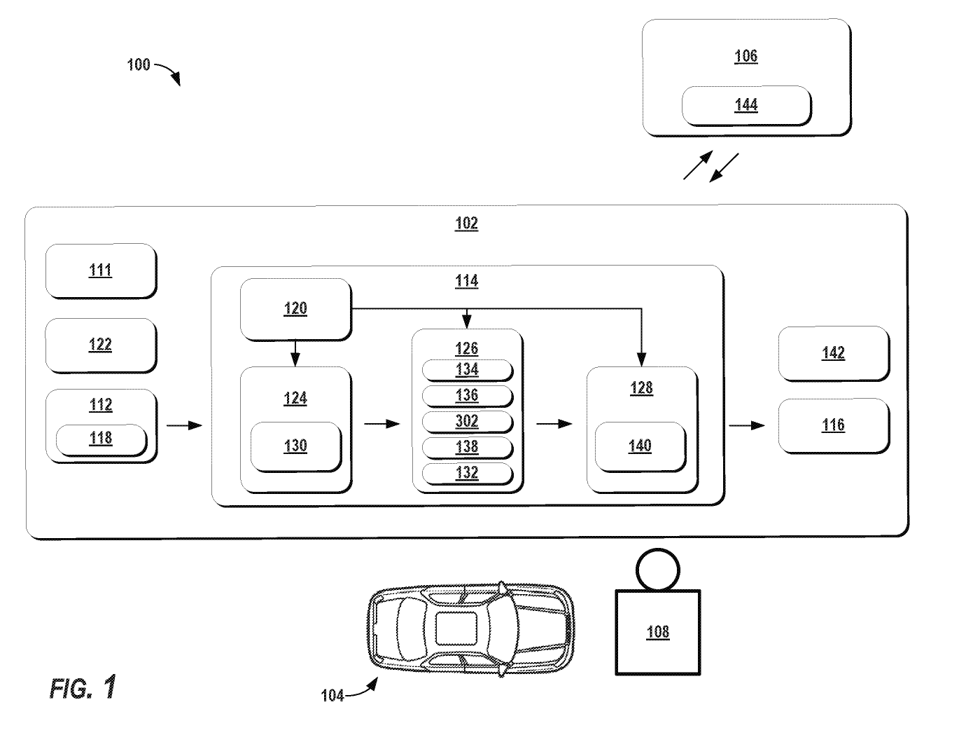

With reference now to the FIGS., example embodiments of the present disclosure will be discussed in further detail. FIG. 1 depicts an example system 100 according to example embodiments of the present disclosure. The system 100 can include a vehicle computing system 102 associated with a vehicle 104. In some implementations, the system 100 can include an operations computing system 106 that is remote from the vehicle 104.

In some implementations, the vehicle 104 can be associated with an entity (e.g., a service provider, owner, manager). The entity can be one that offers one or more vehicle service(s) to a plurality of users via a fleet of vehicles that includes, for example, the vehicle 104. In some implementations, the entity can be associated with only vehicle 104 (e.g., a sole owner, manager). In some implementations, the operations computing system 106 can be associated with the entity. The vehicle 104 can be configured to provide one or more vehicle services to one or more users. The vehicle service(s) can include transportation services (e.g., rideshare services in which user rides in the vehicle 104 to be transported), courier services, delivery services, and/or other types of services. The vehicle service(s) can be offered to users by the entity, for example, via a software application (e.g., a mobile phone software application). The entity can utilize the operations computing system 106 to coordinate and/or manage the vehicle 104 (and its associated fleet, if any) to provide the vehicle services to a user.

The operations computing system 106 can include one or more computing devices that are remote from the vehicle 104 (e.g., located off-board the vehicle 104). For example, such computing device(s) can be components of a cloud-based server system and/or other type of computing system that can communicate with the vehicle computing system 102 of the vehicle 104. The computing device(s) of the operations computing system 106 can include various components for performing various operations and functions. For instance, the computing device(s) can include one or more processor(s) and one or more tangible, non-transitory, computer readable media (e.g., memory devices). The one or more tangible, non-transitory, computer readable media can store instructions that when executed by the one or more processor(s) cause the operations computing system 106 (e.g., the one or more processors, etc.) to perform operations and functions, such as providing data to and/or receiving data from the vehicle 104, for managing a fleet of vehicles (that includes the vehicle 104), etc.

The vehicle 104 incorporating the vehicle computing system 102 can be a ground-based autonomous vehicle (e.g., car, truck, bus, etc.), an air-based autonomous vehicle (e.g., airplane, helicopter, or other aircraft), or other types of vehicles (e.g., watercraft, etc.). The vehicle 104 can be an autonomous vehicle that can drive, navigate, operate, etc. with minimal and/or no interaction from a human operator 108 (e.g., driver). In some implementations, a human operator 108 can be omitted from the vehicle 104 (and/or also omitted from remote control of the vehicle 104). In some implementations, a human operator 108 can be included in the vehicle 104.

The vehicle 104 can be configured to operate in a plurality of operating modes. The vehicle 104 can be configured to operate in a fully autonomous (e.g., self-driving) operating mode in which the vehicle 104 is controllable without user input (e.g., can drive and navigate with no input from a human operator 108 present in the vehicle 104 and/or remote from the vehicle 104). The vehicle 104 can operate in a semi-autonomous operating mode in which the vehicle 104 can operate with some input from a human operator 108 present in the vehicle 104 (and/or remote from the vehicle 104). The vehicle 104 can enter into a manual operating mode in which the vehicle 104 is fully controllable by a human operator 108 (e.g., human driver, pilot, etc.) and can be prohibited from performing autonomous navigation (e.g., autonomous driving). In some implementations, the vehicle 104 can implement vehicle operating assistance technology (e.g., collision mitigation system, power assist steering, etc.) while in the manual operating mode to help assist the human operator 108 of the vehicle 104.

The operating modes of the vehicle 104 can be stored in a memory onboard the vehicle 104. For example, the operating modes can be defined by an operating mode data structure (e.g., rule, list, table, etc.) that indicates one or more operating parameters for the vehicle 104, while in the particular operating mode. For example, an operating mode data structure can indicate that the vehicle 104 is to autonomously plan its motion when in the fully autonomous operating mode. The vehicle computing system 102 can access the memory when implementing an operating mode.

The operating mode of the vehicle 104 can be adjusted in a variety of manners. In some implementations, the operating mode of the vehicle 104 can be selected remotely, off-board the vehicle 104. For example, an entity associated with the vehicle 104 (e.g., a service provider) can utilize the operations computing system 106 to manage the vehicle 104 (and/or an associated fleet). The operations computing system 106 can send data to the vehicle 104 instructing the vehicle 104 to enter into, exit from, maintain, etc. an operating mode. By way of example, the operations computing system 106 can send data to the vehicle 104 instructing the vehicle 104 to enter into the fully autonomous operating mode. In some implementations, the operating mode of the vehicle 104 can be set onboard and/or near the vehicle 104. For example, the vehicle computing system 102 can automatically determine when and where the vehicle 104 is to enter, change, maintain, etc. a particular operating mode (e.g., without user input). Additionally, or alternatively, the operating mode of the vehicle 104 can be manually selected via one or more interfaces located onboard the vehicle 104 (e.g., key switch, button, etc.) and/or associated with a computing device proximate to the vehicle 104 (e.g., a tablet operated by authorized personnel located near the vehicle 104). In some implementations, the operating mode of the vehicle 104 can be adjusted based at least in part on a sequence of interfaces located on the vehicle 104. For example, the operating mode may be adjusted by manipulating a series of interfaces in a particular order to cause the vehicle 104 to enter into a particular operating mode.

The vehicle computing system 102 can include one or more computing devices located onboard the vehicle 104. For example, the computing device(s) can be located on and/or within the vehicle 104. The computing device(s) can include various components for performing various operations and functions. For instance, the computing device(s) can include one or more processor(s) and one or more tangible, non-transitory, computer readable media (e.g., memory devices). The one or more tangible, non-transitory, computer readable media can store instructions that when executed by the one or more processor(s) cause the vehicle 104 (e.g., its computing system, one or more processors, etc.) to perform operations and functions, such as those described herein for detecting anomalies within the vehicle's surrounding environment.

The vehicle 104 can include a communications system 111 configured to allow the vehicle computing system 102 (and its computing device(s)) to communicate with other computing devices. The vehicle computing system 102 can use the communications system 111 to communicate with the operations computing system 106 and/or one or more other remote computing device(s) over one or more networks (e.g., via one or more wireless signal connections). In some implementations, the communications system 111 can allow communication among one or more of the system(s) on-board the vehicle 104. The communications system 111 can include any suitable components for interfacing with one or more network(s), including, for example, transmitters, receivers, ports, controllers, antennas, and/or other suitable components that can help facilitate communication.

As shown in FIG. 1, the vehicle 104 can include one or more sensors 112, an autonomy computing system 114, one or more vehicle control systems 116, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The sensor(s) 112 can be configured to acquire sensor data 118 associated with one or more objects that are proximate to the vehicle 104 (e.g., within a field of view of one or more of the sensor(s) 112). The sensor(s) 112 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 118 can include image data, radar data, LIDAR data, and/or other data acquired by the sensor(s) 112. The object(s) can include, for example, pedestrians, vehicles, bicycles, and/or other objects. The object(s) can be located in front of, to the rear of, to the side of the vehicle 104, etc. The sensor data 118 can be indicative of locations associated with the object(s) within the surrounding environment of the vehicle 104 at one or more times. The sensor(s) 112 can provide the sensor data 118 to the autonomy computing system 114.

In addition to the sensor data 118, the autonomy computing system 114 can retrieve or otherwise obtain map data 120. The map data 120 can provide detailed information about the surrounding environment of the vehicle 104. For example, the map data 120 can provide information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the vehicle 104 in comprehending and perceiving its surrounding environment and its relationship thereto. In some implementations, the vehicle computing system 102 can determine a vehicle route for the vehicle 104 based at least in part on the map data 120.

The vehicle 104 can include a positioning system 122. The positioning system 122 can determine a current position of the vehicle 104. The positioning system 122 can be any device or circuitry for analyzing the position of the vehicle 104. For example, the positioning system 122 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the vehicle 104 can be used by various systems of the vehicle computing system 102 and/or provided to a remote computing device (e.g., of the operations computing system 106). For example, the map data 120 can provide the vehicle 104 relative positions of the surrounding environment of the vehicle 104. The vehicle 104 can identify its position within the surrounding environment (e.g., across six axes) based at least in part on the data described herein. For example, the vehicle 104 can process the sensor data 118 (e.g., LIDAR data, camera data) to match it to a map of the surrounding environment to get an understanding of the vehicle's position within that environment.

The autonomy computing system 114 can include a perception system 124, a prediction system 126, a motion planning system 128, and/or other systems that cooperate to perceive the surrounding environment of the vehicle 104 and determine a motion plan for controlling the motion of the vehicle 104 accordingly. For example, the autonomy computing system 114 can receive the sensor data 118 from the sensor(s) 112, attempt to comprehend the surrounding environment by performing various processing techniques on the sensor data 118 (and/or other data), and generate an appropriate motion plan through such surrounding environment. The autonomy computing system 114 can control the one or more vehicle control systems 116 to operate the vehicle 104 according to the motion plan.

The vehicle computing system 102 (e.g., the autonomy system 114) can identify one or more objects that are proximate to the vehicle 104 based at least in part on the sensor data 118 and/or the map data 120. For example, the vehicle computing system 102 (e.g., the perception system 124) can process the sensor data 118, map data 120, etc. to obtain state data 130. The vehicle computing system 102 can obtain state data 130 indicative of one or more states (e.g., current and/or past state(s)) of one or more objects that are within a surrounding environment of the vehicle 104. For example, the state data 130 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 124 can provide the state data 130 to the prediction system 126.

The prediction system 126 can be configured to predict a motion of the object(s) within the surrounding environment of the vehicle 104. For instance, the prediction system 126 can create prediction data 132 associated with the one or more objects. The prediction data 132 can be indicative of one or more predicted future locations of each respective object. The prediction data 132 can indicate a predicted path associated with each object, if any. The predicted path can be indicative of a predicted motion trajectory along which the respective object is predicted to travel over time. The prediction data 132 can be indicative of the speed at which the object is predicted to travel along the predicted path and/or a timing associated therewith. The prediction data 132 can be created iteratively at a plurality of time steps such that the predicted movement of the objects can be updated, adjusted, confirmed, etc. over time.

The vehicle computing system 102 can also be configured to detect an anomaly within the surrounding environment of the vehicle 104. For instance, the prediction system 126 can include an anomaly detection system 134 that is programmed to detect an anomaly within the surrounding environment of the vehicle 104, as further described herein. An anomaly can be associated with at least one object or a scene of the surrounding environment. An anomaly can be associated with at least one object that is not acting in conformance with the object's expected/predicted behavior and/or motion. Additionally, or alternatively, an anomaly can be associated with a scene of the surrounding environment (e.g., a snap shot of the surrounding environment at a particular time and/or time period) that is not in conformance with expectations for that scene. For example, there may be a plurality of objects within the scene of the surrounding environment (e.g., within an intersection). In some implementations, the behaviors/movements of the plurality of objects can be indicative of an anomaly within the scene (e.g., a large group of jaywalkers). In some implementations, the plurality of objects may themselves be behaving in a non-anomalous manner; however their presence within the scene may be indicative of an anomaly. For example, the presence of a large crowd spread throughout an intersection that does not typically have large crowds can be indicative of an anomalous scene, as further described herein. Accordingly, the vehicle computing system 102 can determine (e.g., while in motion, on-line, etc.) that an object (e.g., actor), a plurality of objects, and/or a scene is moving and/or otherwise behaving in a manner that can be considered an anomaly.

The vehicle computing system 102 can determine the existence of an anomaly within the surrounding environment of the vehicle 104 based at least in part on the state data 130 indicative of the one or more states of the one or more objects within the surrounding environment of the vehicle 104. The vehicle computing system 102 can determine the existence of an anomaly in a variety of manners.

In some implementations, the vehicle computing system 102 can determine the existence of an anomaly based at least in part on a rule(s)-based algorithm. For instance, the vehicle computing system 102 can obtain state data 130 indicative of one or more states of one or more objects that are within the surrounding environment of the vehicle 104. The vehicle computing system 102 can determine an actual motion trajectory of at least one object of the one or more objects and a predicted motion trajectory of the at least one object. The vehicle computing system 102 can determine the existence of the anomaly based at least in part on the actual motion trajectory of the at least one object and the predicted motion trajectory of the at least one object. For example, the vehicle computing system 102 can access data indicative of the one or more rules 136 from an accessible memory onboard the vehicle 104 and/or remote from the vehicle 104. The rule(s) 136 can consider where the at least one object is at a current time relative to where the vehicle computing system 102 (e.g., the prediction system 126) predicted the at least one object would be t seconds ago. The vehicle computing system 102 can employ the rule(s) 136 to compare the at least one object's actual motion trajectory with the predicted motion trajectory to determine the overlap between past prediction locations and current/future locations. In the event that there is a deviation (e.g., above a particular threshold) by the actual object motion trajectory from the predicted object motion trajectory, the vehicle computing system 102 can determine that an anomaly exists (e.g., with the at least one object's motion).

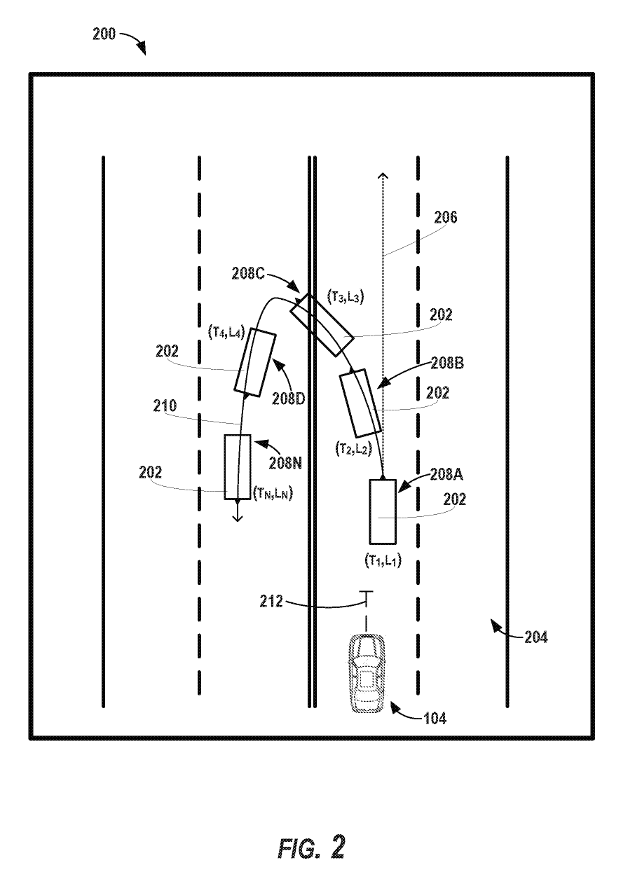

By way of example, FIG. 2 depicts a first example environment 200 with at least one object 202 according to example embodiments of the present disclosure. The vehicle 104 can be travelling along a travel way 204 such as, for example, a bridge. The vehicle computing system 102 can identify the object 202 within the surrounding environment of the vehicle 104. The object 202 can be a vehicle within the surrounding environment 200 of the vehicle 104. The object 202 can also be travelling in the travel way 204 (e.g., on the bridge ahead of the vehicle 104). The vehicle computing system 102 can predict that the object 202 will continue to travel in accordance with a predicted motion trajectory 206. The predicted motion trajectory 206 can correspond to a typical object motion within the travel way 204 (e.g., straight motion across the bridge).

The object 202 may, however, deviate from this predicted motion trajectory 206. For instance, the object 202 may perform a u-turn maneuver in the middle of the travel way 204. The vehicle computing system 102 can obtain state data 130 indicative of one or more states of the object 202 before, during, and/or after it performs such a maneuver. The state data 130 can be indicative of a plurality of states including a first state 208A of the object 202 (e.g., at a first location L₁, a first time T₁, etc.), a second state 208B of the object 202 (e.g., at a second location L₂, a second time T₂, etc.), a third state 208C of the object 202 (e.g., at a third location L₃, a third time T₃, etc.), a fourth state 208D of the object 202 (e.g., at a fourth location L₄, a fourth time T₄, etc.), . . . an N^{th} state 208N of the object 202 (e.g., at a N^{th} location L_{N}, an N^{th} time T_{N}, etc.). The vehicle computing system 102 can determine an actual motion trajectory 210 of the object 202 based at least in part on the state data 130 (e.g., including the first to N^{th} states). The actual motion trajectory 210 can be associated with a u-turn maneuver. The vehicle computing system 102 can compare the actual motion trajectory 210 (e.g., the u-turn) to the previously predicted motion trajectory 206 (e.g., straight path) to determine that an anomaly exists with respect to the object's motion (e.g., due to the deviation/difference between these trajectories), and, thus, that the object's predicted trajectory 206 is not accurate.

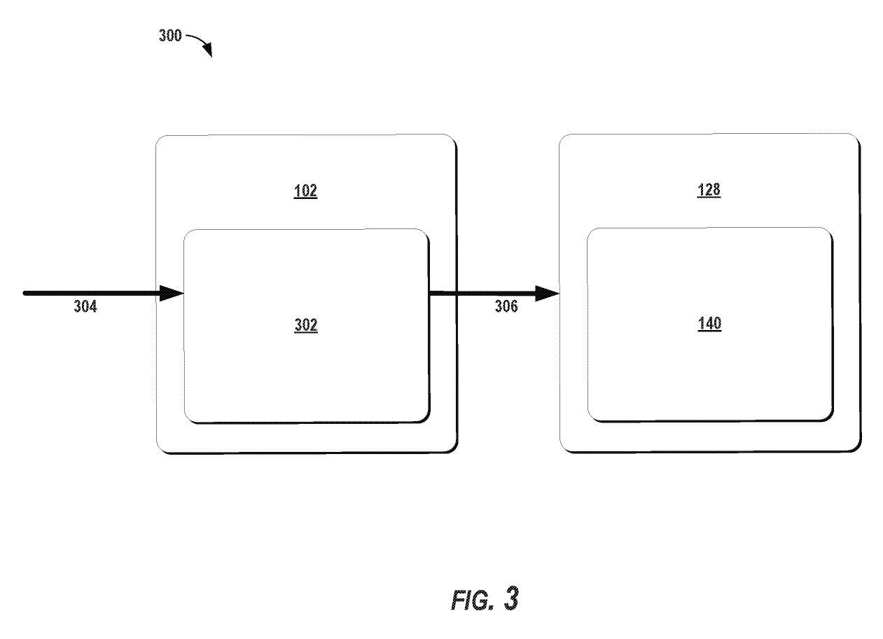

In some implementations, the vehicle computing system 102 (e.g., the prediction system 126, the anomaly detector 134) can determine the existence of the anomaly within the surrounding environment of the vehicle 104 based at least in part on a model (e.g., a machine-learned anomaly detection model). For example, FIG. 3 depicts a diagram 300 of an example implementation of a model 302 according to example embodiments of the present disclosure. The vehicle computing system 102 can include, employ, and/or otherwise leverage the model 302 to help determine whether an anomaly exists within the surrounding environment of the vehicle 104. In particular, the model 302 can be a machine-learned anomaly detection model. For example, the machine-learned anomaly detection model can be or can otherwise include one or more various model(s) such as, for example, neural networks (e.g., deep neural networks), or other multi-layer non-linear models. The machine-learned anomaly detection model can include neural networks such as, for example, a convolutional neural networks, recurrent neural networks (e.g., long short-term memory recurrent neural networks), feed-forward neural networks, and/or other forms of neural networks.

The model 302 can be trained to determine the existence of an anomaly within the surrounding environment of the vehicle 104. For instance, training techniques (e.g., supervised training techniques) can be performed to train the model 302 to determine whether an object within the vehicle's surrounding environment and/or a scene of the surrounding environment is anomalous. By way of example, the model 302 can be trained based on, for example, a number of sets of data from previous events that are indicative of one or more anomalies associated with an object and/or a scene (e.g., previous vehicle logs, etc.). The training data can include labeled state data, prediction data and/or other types of data labelled with known instances of anomalies. This can help the model 302 learn to which object(s) and/or scenes are anomalous. In some implementations, the training data can include labeled state data, prediction data and/or other types of data labelled with known instances that are not anomalies. This can help the model 302 learn to identify which object(s) and/or scenes are non-anomalous. In some implementations, the training data can be based at least in part on the anomalies identified using the rules-based approach, as described herein, to help train a machine-learned model for anomaly detection. The training data can be used to train the model 302 offline, which can then be used as an additional, or alternative, approach for predicting anomalies (e.g., with less latency). Ultimately, the training data can allow the model 302 (e.g., the machine-learned anomaly detection model) to be trained to determine whether an anomaly exists within the surrounding environment of the vehicle 104 as well as whether the anomaly is associated with one or more objects and/or the scene itself.

The model 302 can be configured to receive input data 304 and provide output data 306 based at least in part on the input data 304. For example, the input data 304 for the model 302 can include the state data 130 indicative of the one or more states of the one or more objects, as described herein. The input data 304 can also include the prediction data 132 indicative of one or more predicted motion trajectories of one or more objects within the surrounding environment of the vehicle 104. In some implementations, the input data 304 can include the map data 120 and/or other types of data.

The vehicle computing system 102 can provide the input data 304 to the model 302 and obtain an output (e.g., output data 306). For instance, the vehicle computing system 102 (e.g., the prediction system 126, the anomaly detector 134) can obtain data indicative of the model 302 from an accessible memory onboard the vehicle 104 and/or from a memory that is remote from the vehicle 104 (e.g., via one or more wireless network(s)). The vehicle computing system can input data (e.g., state date, prediction data, etc.) into the machine-learned model. The model 302 can process the input data 304 to detect an anomaly (e.g., associated with an object and/or associated with a scene) and provide an output (e.g., output data 306) indicative of whether an anomaly exists. In some implementations, the model 302 can include a classifier (e.g., binary anomaly classifier) that provides an output indicative of the existence of an anomaly in a binary manner. In some implementations, the model 302 can include a regression model (e.g., linear/logistic regression, etc.) that provides an output indicative of a value in a continuous value range. This type of model (e.g., a continuous anomaly regression) can indicate, for example, the likelihood that an anomaly exists (e.g., as a percentage, decimal, etc.). The likelihood can be based at least in part on a confidence level of the model 302 as it processes the input data 304. In some implementations, the output data 306 of the model 302 can also indicate the type of the anomaly. In some implementations, the output data 306 of the model 302 can indicate whether the anomaly is associated with one or more object(s) and/or the scene of the surrounding environment of the vehicle 104.

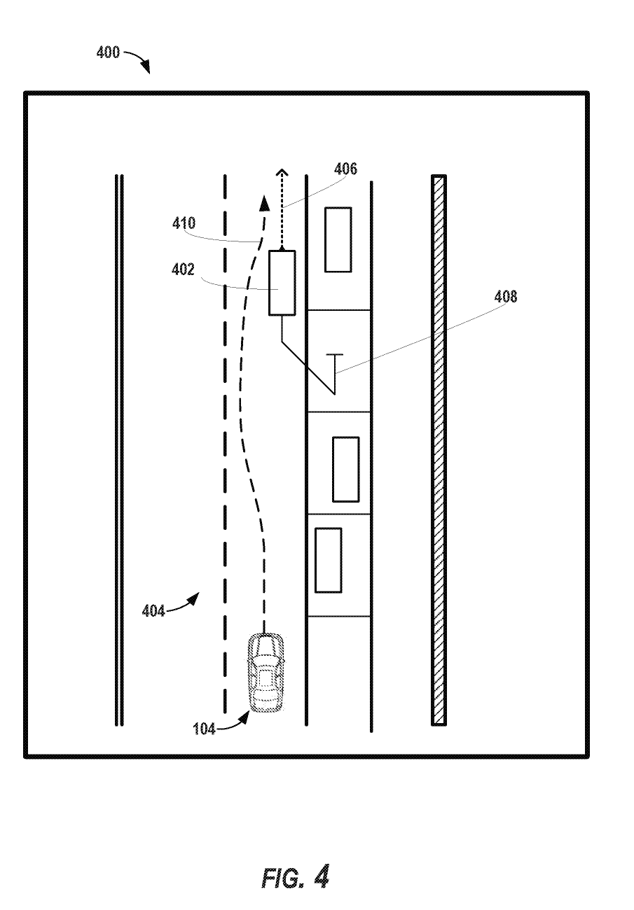

FIG. 4 depicts a second example environment 400 according to example embodiments of the present disclosure. The vehicle computing system 102 can determine the existence of an anomaly associated with the object 402 using the model 302. For instance, the vehicle computing system 102 (e.g., the prediction system 126) can identify an object 402 within the surrounding environment 400 of the vehicle 104 (e.g., based at least in part on sensor data 118). The object 402 can be a vehicle within the surrounding environment 400 of the vehicle 104. The object 402 can also be travelling in the travel way 404 (e.g., on a one-way road ahead of the vehicle 104). The vehicle computing system 102 can predict that the object 402 will travel in accordance with a predicted motion trajectory 406 (e.g., straight within a travel lane of the one-way road). Additionally, or alternatively, the vehicle computing system 102 may predict that the object 402 will stop within the travel way 404 based at least in part on the state data 130 associated with the object 402 (e.g., indicating that the vehicle's speed is decreasing over time). However, once the object 402 is stopped, the object 402 may begin to travel in a reverse direction, against the intended direction of the travel way 404 in the manner shown by the actual motion trajectory 406 in FIG. 4 (e.g., in order to parallel park into a parking space). The vehicle computing system 102 can input the state data 130 indicative of the one or more states of the object 402 (e.g., vehicle's location, speed, heading, etc. at various times), the predicted motion trajectory 406, map data 120 (e.g., indicating the intended direction of the travel 404), and/or other data into the model 302. The model 302 can process such data and provide an output (e.g., output data 306) indicating that the object's motion is an anomaly, the type of the anomaly (e.g., associated with a parallel parking maneuver), and/or the likelihood that the object's motion is an anomaly.

Returning to FIG. 1, in some implementations, the vehicle computing system 102 can determine the existence of the anomaly based at least in part on one or more anomaly categories 138. Data indicative of the one or more anomaly categories 138 can be stored in an accessible memory onboard the vehicle 104 and/or in accessible memory that is remote from the vehicle 104 (e.g., via one or more wireless network(s)). The anomaly categories 138 (e.g., definitions) can be generated for different types of anomalies (e.g., u-turns, parallel parking, wrong way down one-way street, large unexpected crowds, etc.). The anomaly categories 138 can be generated based on data previously acquired by a vehicle 104 (e.g., an autonomous vehicle in an associated fleet) that is indicative of a previously detected anomaly. As one or more objects and/or other aspects of a surrounding environment are observed and analyzed, the vehicle computing system 102 can determine if they fit into one or more of the different categories. If so, an anomaly of the particular type defined by the category can be predicted.

By way of example, the vehicle computing system 102 can determine an actual motion trajectory 210 (e.g., 180 degree left hand turn) of an object 202 (e.g., another vehicle on a bridge) based at least in part on the state data 130 indicative of the one or more states 208A-N of the object 202. The vehicle computing system 102 can access data indicative of the one or more anomaly categories 138 from an accessible memory located onboard the vehicle 104 and/or remote from the vehicle 104. The vehicle computing system 102 can determine the existence of an anomaly (e.g., a u-turn maneuver) based at least in part on the actual motion trajectory of the object fitting into at least one of the one or more anomaly categories 138 (e.g., a u-turn category).

In another example, the vehicle computing system 102 can determine an actual motion trajectory 408 (e.g., reverse maneuver, parallel parking maneuver, etc.) of an object 402 (e.g., another vehicle on a one-way road) based at least in part on the state data 130 indicative of the one or more states of the object 402. The vehicle computing system 102 can determine the existence of an anomaly (e.g., a parallel parking maneuver) based at least in part on the actual motion trajectory 410 of the object 402 fitting into at least one of the one or more anomaly categories 138 (e.g., a parallel parking category). In this way, the vehicle computing system 102 can determine whether the anomaly exists based at least in part on the anomaly categories 138.

Additionally, or alternatively, the vehicle computing system 102 can determine an anomaly is associated with a scene of the surrounding environment of the vehicle 104. A scene can be indicative of one or more objects, the respective motion of the one or more objects, geographic features, etc. of a surrounding environment of the vehicle 104 during a particular time (e.g., a point in time, during a time period, etc.). The vehicle computing system 102 can obtain state data 130 indicative of the state(s) of the one or more objects within the scene (e.g., the 360 degree view of the vehicle 104) as well as other data (e.g., map data 120) associated with the surrounding environment. The vehicle computing system 102 can determine the existence of an anomaly in the scene based at least in part on such data. The vehicle computing system 102 can determine that an anomaly is associated with an entire scene based at least in part on any, or any combination, of the techniques described herein. For example, the vehicle computing system 102 can access rule(s) 136 that have been configured to enable the vehicle computing system 102 to determine whether the scene is anomalous. Additionally, or alternatively, the model 302 (e.g., the machine-learned anomaly detection model) and/or another model can be configured to determine whether an anomalous scene exists in the surrounding environment of the vehicle 104. Additionally, or alternatively, the vehicle computing system 102 can utilize one or more anomaly categories 138 that can define categories of anomalies associated with a scene.

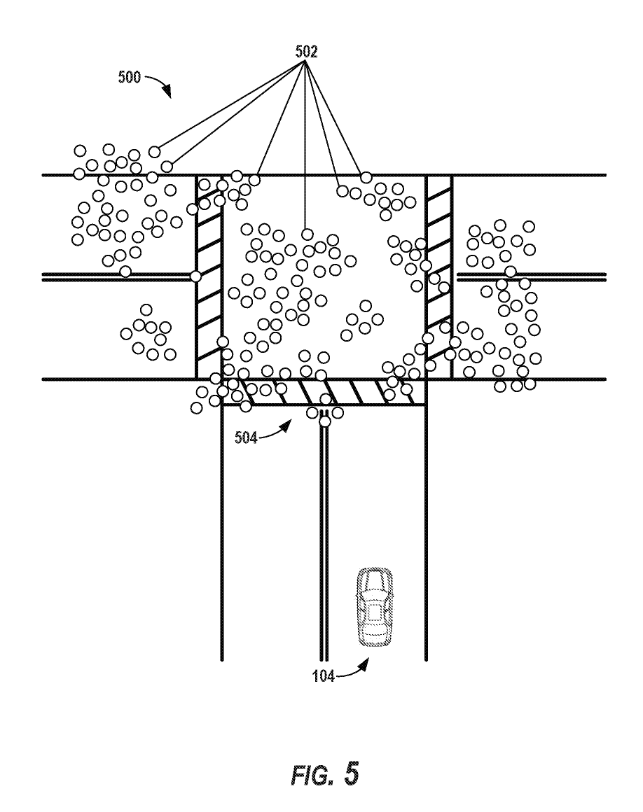

By way of example, FIG. 5 depicts an example scene of a surrounding environment 500 according to example embodiments of the present disclosure. As shown, the scene of the surrounding environment can include a plurality of objects 502. For example, the plurality of objects 502 can represent a plurality of pedestrians that are located throughout an intersection that is ahead of the vehicle 104. The vehicle computing system 102 can obtain state data 130 indicative of one or more states of the plurality of objects 502 that are within the surrounding environment 500 of the vehicle 104. The vehicle computing system 102 can also obtain data associated with the surrounding environment 500 such as, for example, map data 120 associated with a geographic area 504 (e.g., the intersection) in which the plurality of objects 502 are located and/or other data (e.g., sensor data 118, etc.). The vehicle computing system 102 can determine the existence of the anomaly associated with the scene of the surrounding environment 500 of the vehicle 104 based at least in part on state data 130 indicative of one or more states of each of the plurality of objects 502 within the surrounding environment 500 of the vehicle 104 and the data associated with the surrounding environment 500. For example, the vehicle computing system 102 can determine that the geographic area 504 is one in which there is not typically a large crowd of pedestrians and/or that no event (e.g., parade) is scheduled to take place in the geographic area 504. As such, the vehicle computing system 102 can determine that the scene of the surrounding environment 500 is an anomaly because the scene includes a plurality of objects 502 (e.g., a large crowd of pedestrians) that is atypical for the surrounding environment 500 (e.g., the associated geographic area 504).

Returning to FIG. 1, the vehicle computing system 102 can generate data indicative of the existence of the anomaly. For instance, the prediction system 126 can generate prediction data 132 indicative of the existence of the anomaly (e.g., associated with at least one object, associated with the scene). In some implementations, the prediction data 132 can indicate that the predicted motion trajectories of one or more objects are not accurate (e.g., due to the anomaly). In some implementations, the prediction data 132 can indicate that an object and/or the scene is an anomaly within the vehicle's surrounding environment. Additionally, or alternatively, the prediction data 132 can be indicative of a likelihood that the anomaly exists (e.g., as outputted from the model 302). The vehicle computing system (e.g., the prediction system 126) can provide the prediction data 132 to the motion planning system 128 of the vehicle 104. In some implementations, the output data 306 of the model 302 can be provided to the motion planning system 128 (e.g., as shown in FIG. 3).

The motion planning system 128 can determine a motion plan 140 for the vehicle 104. A motion plan 140 can include vehicle actions (e.g., planned vehicle trajectories, speed(s), acceleration(s), other actions, etc.) with respect to the objects proximate to the vehicle 104 as well as the objects' predicted movements. For instance, the motion planning system 128 can implement an optimization algorithm that considers cost data associated with a vehicle action as well as other objective functions (e.g., cost functions based on speed limits, traffic lights, etc.), if any, to determine optimized variables that make up the motion plan 140. The motion planning system 128 can determine that the vehicle 104 can perform a certain action (e.g., pass an object) without increasing the potential risk to the vehicle 104 and/or violating any traffic laws (e.g., speed limits, lane boundaries, signage).

In the event that an anomaly is detected within the vehicle's surrounding environment, the vehicle computing system 102 can determine a motion plan 140 for the vehicle 104 based at least in part the existence of the anomaly within the surrounding environment of the vehicle 104 (e.g., the data indicative of the existence of the anomaly). The vehicle computing system 102 (e.g., the motion planning system 128) can weigh the anomaly during its cost data analysis as it determines an optimized trajectory through the surrounding environment. In some implementations, the existence of the anomaly may not ultimately change the motion of the vehicle 104. In some implementations, the motion plan 140 may define the vehicle's motion such that the vehicle 104 avoids the anomalous object(s), reduces speed to give more leeway around anomalous object(s), proceeds cautiously within an anomalous scene, performs a stopping action, etc. By way of example, the motion plan 140 of the vehicle 104 may indicate that the vehicle 104 is to perform a stopping action 212 for an anomalous object (e.g., another vehicle performing a u-turn maneuver), as shown in FIG. 2. In another example, the motion plan 140 of the vehicle 104 may include a planned vehicle trajectory 410 that aims to avoid an anomalous object (e.g., to perform a nudging action to avoid the vehicle that is parallel parking), as shown in FIG. 4.

The vehicle computing system 102 can cause the vehicle 104 to initiate travel in accordance with the motion plan 140. The motion plan 140 can be provided to a vehicle controller that is configured to implement the motion plan 140. For example, the vehicle controller can translate the motion plan 140 into instructions for the vehicle control systems 116 (e.g., acceleration control, brake control, steering control, etc.). By way of example, the vehicle controller can translate a determined motion plan 140 into instructions to adjust the steering of the vehicle 104 “X” degrees, apply a certain magnitude of braking force, etc. The vehicle controller can send one or more control signals to the responsible vehicle control component (e.g., braking control system, steering control system, acceleration control system) to execute the instructions and implement the motion plan 140.

In some implementations, the vehicle computing system 102 can alert an operator 108 (e.g., onboard the vehicle 104, remote from the vehicle 104) of the existence of the anomaly. For instance, the vehicle computing system 102 can send data associated with the anomaly for display via one or more human-machine interfaces 142. The human-machine interface(s) 142 can include display devices (e.g., display screen, CRT, LCD, plasma screen, touch screen, TV, projector, and/or other suitable display components) onboard the vehicle 104. In some implementations, the vehicle computing system 102 can send data associated with the anomaly for display via one or more human-machine interfaces 142 that are remote from the vehicle 104. The human-machine interface(s) can obtain the data associated with the anomaly and display an alert indicating the existence of an anomaly via a user interface on a display device. In this way, a human operator 108 can identify when and in what scenarios the vehicle computing system 102 is detecting anomalies within its surrounding environment.

In some implementations, the vehicle computing system 102 can request vehicle assistance (e.g., from a service provider) to address an anomaly. For instance, the vehicle computing system 102 can provide data associated with the anomaly to a remote computing system (e.g., the operations computing system 106). Additionally, or alternatively, the vehicle computing system 102 can provide data requesting assistance with respect to the anomaly (e.g., requesting a re-route with respect to a large unexpected crowd). The remote computing system (e.g., the operations computing system 106) can provide assistance to the vehicle 104 based at least in part on such request. By way of example, a human operator 108 can take over control of the vehicle 104 (at least partially) and/or the remote computing system can provide data to the vehicle 104 instructing the vehicle 104 to perform a particular vehicle action (e.g., pull over, enter park mode, etc.).

In some implementations, data associated with the detected anomalies can be used for testing/training of a vehicle computing system 102. For instance, the vehicle computing system 102 can store data associated with the anomaly in a memory onboard the vehicle 104 and/or remote from the vehicle 104 (e.g., in a memory that is remote from the vehicle 104). Such data can be included in a testing dataset 144 that can be used for testing a vehicle autonomy system and its associated software. For example, the vehicle computing system 102 can provide, for inclusion in a data set stored in a memory (e.g., the testing dataset 144), at least one of data indicative of the anomaly or the state data 130 indicative of the one or more states of the one or more objects. Additionally, or alternatively, the testing dataset 144 can include the prediction data 132 associated with anomalous objects/scenes, the state data and/or prediction data associated with non-anomalous objects/scenes, and/or a combination thereof. This can allow vehicle autonomy system software to be tested offline based on testing data exclusively indicative of anomalies, free of anomalies, and/or indicative of both anomalies and non-anomalies. Accordingly, the autonomy system software can be developed to better predict the motion of objects (e.g., anomalous objects) as well as improve the planning of vehicle motion (e.g., with respect to anomalous objects/scenes).

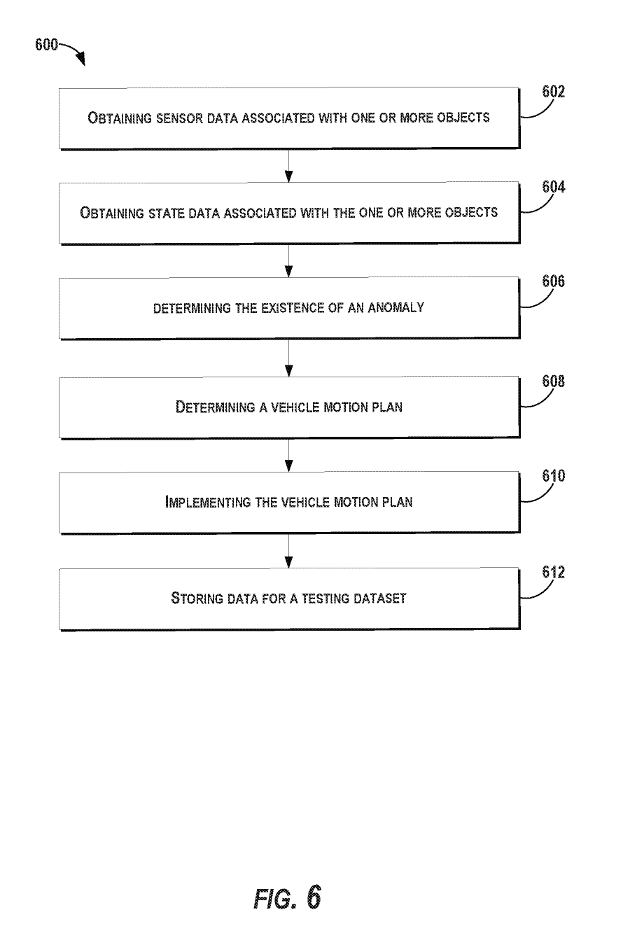

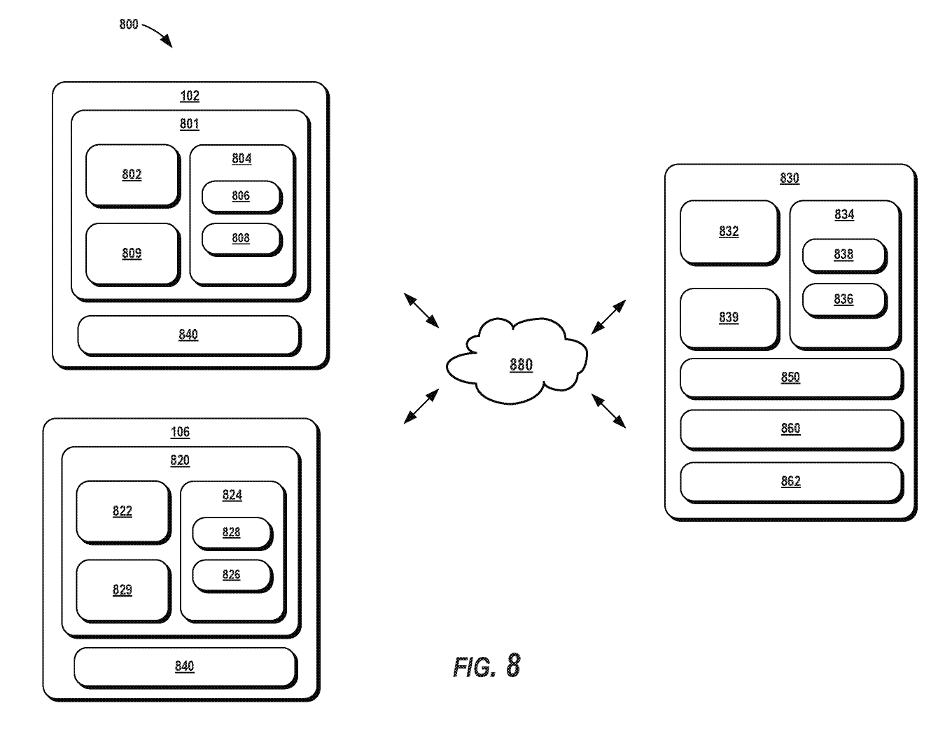

FIG. 6 depicts a flow diagram of an example method 600 for anomaly detection according to example embodiments of the present disclosure. One or more portion(s) of the method 600 can be implemented by one or more computing devices such as, for example, the one or more computing device(s) of the vehicle computing system 102 and/or other systems. Each respective portion of the method 600 can be performed by any (or any combination) of the one or more computing devices. Moreover, one or more portion(s) of the method 600 can be implemented as an algorithm on the hardware components of the device(s) described herein (e.g., as in FIGS. 1 and 8), for example, to detect anomalies within a surrounding environment of an autonomous vehicle (e.g., associated with at least one object within the surrounding environment). FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (602), the method 600 can include obtaining sensor data associated with one or more objects. For instance, the vehicle computing system 102 can obtain sensor data 118 associated with one or more objects within the surrounding environment of a vehicle 104. The object(s) can include, for example, pedestrians, vehicles, bicycles, etc. within the surrounding environment of the vehicle 104. As described herein, the vehicle computing system 102 can obtain the sensor data 118 via one or more sensor(s) onboard the vehicle 104.

At (604), the method 600 can include obtaining state data associated with the one or more objects. For instance, the vehicle computing system 102 can obtain state data 130 indicative of one or more states of one or more objects that are within a surrounding environment of a vehicle 104. As described herein, the state data 130 can be indicative of the current and/or past state(s) of the object(s) within the surrounding environment of the vehicle 104. For example, the state data 130 can be indicative of a current and/or past location, heading, speed, object class, etc. of each of the one or more objects within the surrounding environment.

At (606), the method 600 can include determining the existence of an anomaly. For instance, the vehicle computing system 102 can determine an existence of an anomaly within the surrounding environment of the vehicle 104 based at least in part on the state data 130 indicative of the one or more states of the one or more objects within the surrounding environment of the vehicle 104. In some implementations, the anomaly can be associated with at least one object 202, 402 of the one or more objects within the surrounding environment 200, 400. The vehicle computing system 102 can determine the existence of the anomaly associated with at least one object 202, 402 within the surrounding environment 200, 400 of the vehicle 104 based at least in part on state data 130 indicative of one or more states of the at least one object 202, 402 within the surrounding environment of the vehicle 104. The anomaly can be, for example, associated with at least one of a u-turn maneuver of an object (e.g., vehicle) or a parallel parking maneuver of the object (e.g., vehicle), as described herein.

The vehicle computing system 102 can determine the existence of the anomaly within the surrounding environment 200, 400 of the vehicle 104 based at least in part on at least one of a rule-based algorithm (e.g., including rule(s) 136), a model (e.g., machine-learned model 302), or one or more anomaly categories 138. For example, the vehicle computing system 102 can determine an actual motion trajectory 210, 408 of the at least one object 202, 402 and a predicted motion trajectory 206, 406 of the at least one object 202, 402. The vehicle computing system 102 can determine the existence of the anomaly based at least in part on a comparison of the actual motion trajectory 210, 408 of the at least one object 202, 402 and the predicted motion trajectory 206, 406 of the at least one object 202, 402.

Additionally, or alternatively, the vehicle computing system 102 can obtain data indicative of a machine-learned anomaly detection model. The vehicle computing system 102 can input the state data 130 indicative of the one or more states of the one or more objects (and/or other data) into the machine-learned anomaly detection model. The vehicle computing system 102 can obtain an output from the machine-learned anomaly detection model. The output can be indicative of the existence of the anomaly within the surrounding environment of the vehicle 104. In some implementations, the output can indicate that the anomaly is associated with at least one object of the one or more objects. In some implementations, the output can indicate a likelihood that the anomaly exists.

Additionally, or alternatively, the vehicle computing system 102 can employ one or more anomaly categories 138 to help determine the existence of an anomaly. For instance, the vehicle computing system 102 can determine an actual motion trajectory of at least one object based at least in part on the state data 130 indicative of the one or more states of the object. The vehicle computing system 102 can access data indicative of one or more anomaly categories 138, for example, as described herein. The vehicle computing system 102 can determine the existence of the anomaly based at least in part on the actual motion trajectory of the at least one object fitting into at least one of the one or more anomaly categories 138.

At (608), the method 600 can include determine a vehicle motion plan. The vehicle computing system 102 can determine a motion plan 140 for the vehicle 104 based at least in part on the existence of the anomaly within the surrounding environment of the vehicle 104. For instance, the prediction system 126 can generate data indicative of the existence of the anomaly and provide such data to the motion planning system 128 of the vehicle 104. The motion planning system 128 can generate a motion plan 140 for the vehicle 104 based at least in part on the anomaly. The vehicle computing system 102 can implement the motion plan 140, at (610). For example, the vehicle computing system 102 can cause the vehicle to travel in accordance with the motion plan 140 through the vehicle's surrounding environment, as described herein.

In some implementations, at (612), the method 600 can include storing data for use as a testing dataset. For instance, the vehicle computing system 102 can store data associated with the anomaly in a memory. The memory can be an accessible memory onboard or off-board the vehicle 104. The data associated with the anomaly can be included in a testing dataset 144 used for testing a vehicle autonomy computing system. The data can include, for example, state data and/or the prediction data associated with anomalous objects/scenes, the state data and/or prediction data associated with non-anomalous objects/scenes, a combination thereof, and/or other types of data.

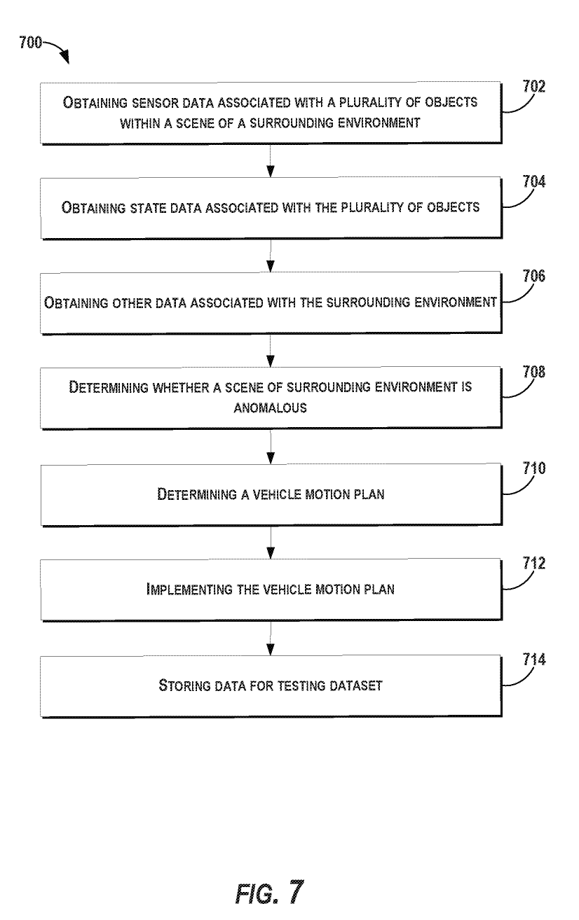

FIG. 7 depicts a flow diagram of another example method 700 for anomaly detection according to example embodiments of the present disclosure. One or more portion(s) of the method 700 can be implemented by one or more computing devices such as, for example, the one or more computing device(s) of the vehicle computing system 102 and/or other systems. Each respective portion of the method 700 can be performed by any (or any combination) of the one or more computing devices. Moreover, one or more portion(s) of the method 600 can be implemented as an algorithm on the hardware components of the device(s) described herein (e.g., as in FIGS. 1 and 8), for example, to detect anomalies within a surrounding environment of an autonomous vehicle (e.g., associated with a scene of the surrounding environment). FIG. 7 depicts elements performed in a particular order for purposes of illustration and discussion and is not meant to be limiting.

At (702), the method 700 can include obtaining sensor data associated with a plurality of objects. For instance, the one or more objects within the surrounding environment of a vehicle 104 can include a plurality of objects 502. The vehicle computing system 102 can obtain sensor data 118 associated with the plurality of objects 502 within the surrounding environment 500 of a vehicle 104.

At (704), the method 700 can include obtaining state data associated with the plurality of objects. For instance, the vehicle computing system 102 can obtain state data 130 indicative of one or more states of each of the plurality of objects 502 that are within a surrounding environment 500 of a vehicle 104. The state data 130 can be indicative of the current and/or past state(s) of the plurality of objects within the surrounding environment 500 of the vehicle 104. For example, the state data 130 can be indicative of a current and/or past location, heading, speed, object class, etc. of each of the plurality of objects within the surrounding environment 500. The vehicle computing system 102 can also obtain data associated with the surrounding environment of the vehicle 104, at (706). For example, the vehicle computing system 102 can obtain map data 120 and/or sensor data 118 that are indicative of characteristics (e.g., travel way boundaries, travel way types, traffic rules, events, etc.) associated with the surrounding environment of the vehicle 104.

At (708), the method 700 can include determining whether a scene of the surrounding environment is anomalous. As described herein, an anomaly can be associated with a scene of the surrounding environment 500 of the vehicle 104 (e.g., a large unexpected crowd). The vehicle computing system 102 can determine the existence of the anomaly associated with the scene of the surrounding environment 500 of the vehicle 104 based at least in part on state data 130 indicative of one or more states of each of the plurality of objects 502 within the surrounding environment 500 of the vehicle 104 and the data associated with the surrounding environment 500 (e.g., the map data 120). The vehicle computing system 102 can determine the existence of the anomaly associated with the scene of the surrounding environment 500 of the vehicle 104 based at least in part on at least one of a rule-based algorithm (e.g., including rule(s) 136), a model (e.g., machine-learned model 302), or one or more anomaly categories 138 (e.g., categories defining anomalous scenes).

At (710), the method 700 can include determine a vehicle motion plan. The vehicle computing system 102 can determine a motion plan 140 for the vehicle 104 based at least in part on the existence of the anomaly associated with the scene of the surrounding environment. The vehicle computing system 102 can implement the motion plan, at (712). For example, the vehicle computing system 102 can cause the vehicle to travel in accordance with the motion plan 140 through the vehicle's surrounding environment to navigate around and/or otherwise avoid the anomalous aspects of the scene (e.g., the large crowd of pedestrians).

In some implementations, at (714), the method 700 can include storing data for use as a testing dataset. For instance, the vehicle computing system 102 can store data associated with the anomaly associated with the scene of the surrounding environment in a memory, as similarly described herein. Such data can be included in a testing dataset 144 used for testing a vehicle autonomy computing system (e.g., to see how the system reacts to an anomalous scene).

FIG. 8 depicts example system components of an example system 800 according to example embodiments of the present disclosure. The example system 800 can include the vehicle computing system 102, the operations computing system 106, and a machine learning computing system 830 that are communicatively coupled over one or more network(s) 880.

The vehicle computing system 102 can include one or more computing device(s) 801. The computing device(s) 801 of the vehicle computing system 102 can include processor(s) 802 and a memory 804 (e.g., onboard the vehicle 104). The one or more processors 802 can be any suitable processing device (e.g., a processor core, a microprocessor, an ASIC, a FPGA, a controller, a microcontroller, etc.) and can be one processor or a plurality of processors that are operatively connected. The memory 804 can include one or more non-transitory computer-readable storage media, such as RAM, ROM, EEPROM, EPROM, one or more memory devices, flash memory devices, etc., and combinations thereof.

The memory 804 can store information that can be accessed by the one or more processors 802. For instance, the memory 804 (e.g., one or more non-transitory computer-readable storage mediums, memory devices) can include computer-readable instructions 806 that can be executed by the one or more processors 802. The instructions 806 can be software written in any suitable programming language or can be implemented in hardware. Additionally, or alternatively, the instructions 806 can be executed in logically and/or virtually separate threads on processor(s) 802.

For example, the memory 804 can store instructions 806 that when executed by the one or more processors 802 cause the one or more processors 802 (the computing system 102) to perform operations such as any of the operations and functions of the vehicle computing system 102, the vehicle 104, or for which the vehicle computing system 102 is configured, as described herein, the operations for anomaly detection (e.g., one or more portions of methods 600 and/or 700), and/or any other operations and functions for the vehicle computing system 102, as described herein.

The memory 804 can store data 808 that can be obtained, received, accessed, written, manipulated, created, and/or stored. The data 808 can include, for instance, sensor data, state data, data associated with and/or indicative of anomalies, prediction data, data indicative of rule(s), data indicative of model(s), data indicative of anomaly categories, testing data, motion planning data, map data, other data associated with a surrounding environment, input data, data indicative of model outputs, and/or other data/information described herein. In some implementations, the computing device(s) 801 can obtain data from one or more memory device(s) that are remote from the vehicle 104.

The computing device(s) 801 can also include a communication interface 809 used to communicate with one or more other system(s) on-board the vehicle 104 and/or a remote computing device that is remote from the vehicle 104 (e.g., the other systems of FIG. 8, etc.). The communication interface 809 can include any circuits, components, software, etc. for communicating via one or more networks (e.g., 880). In some implementations, the communication interface 809 can include, for example, one or more of a communications controller, receiver, transceiver, transmitter, port, conductors, software and/or hardware for communicating data/information.

The operations computing system 106 can perform the operations and functions for managing vehicles (e.g., a fleet of autonomous vehicles) and/or otherwise described herein. The operations computing system 106 can be located remotely from the vehicle 104. For example, the operations computing system 106 can operate offline, off-board, etc. The operations computing system 106 can include one or more distinct physical computing devices.

The operations computing system 106 can include one or more computing devices 820. The one or more computing devices 820 can include one or more processors 822 and a memory 824. The one or more processors 822 can be any suitable processing device (e.g., a processor core, a microprocessor, an ASIC, a FPGA, a controller, a microcontroller, etc.) and can be one processor or a plurality of processors that are operatively connected. The memory 824 can include one or more non-transitory computer-readable storage media, such as RAM, ROM, EEPROM, EPROM, one or more memory devices, flash memory devices, etc., and combinations thereof.

The memory 824 can store information that can be accessed by the one or more processors 822. For instance, the memory 824 (e.g., one or more non-transitory computer-readable storage mediums, memory devices) can store data 826 that can be obtained, received, accessed, written, manipulated, created, and/or stored. The data 826 can include, for instance, data indicative of model(s), testing data, data associated with vehicle(s), and/or other data or information described herein. In some implementations, the operations computing system 106 can obtain data from one or more memory device(s) that are remote from the operations computing system 106.

The memory 824 can also store computer-readable instructions 828 that can be executed by the one or more processors 822. The instructions 828 can be software written in any suitable programming language or can be implemented in hardware. Additionally, or alternatively, the instructions 828 can be executed in logically and/or virtually separate threads on processor(s) 822. For example, the memory 824 can store instructions 828 that when executed by the one or more processors 822 cause the one or more processors 822 to perform any of the operations and/or functions of the operations computing system 106 and/or other operations and functions.

The computing device(s) 820 can also include a communication interface 829 used to communicate with one or more other system(s). The communication interface 629 can include any circuits, components, software, etc. for communicating via one or more networks (e.g., 880). In some implementations, the communication interface 829 can include for example, one or more of a communications controller, receiver, transceiver, transmitter, port, conductors, software and/or hardware for communicating data/information.

According to an aspect of the present disclosure, the vehicle computing system 102 and/or the operations computing system 106 can store or include one or more machine-learned models 840. As examples, the machine-learned models 840 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), or other forms of neural networks. The machine-learned models 840 can include the model 302 and/or other model(s), as described herein.

In some implementations, the vehicle computing system 102 and/or the operations computing system 106 can receive the one or more machine-learned models 840 from the machine learning computing system 830 over the network(s) 880 and can store the one or more machine-learned models 840 in the memory of the respective system. The vehicle computing system 102 and/or the operations computing system 106 can use or otherwise implement the one or more machine-learned models 840 (e.g., by processor(s) 802, 822). In particular, the vehicle computing system 102 and/or the operations computing system 106 can implement the machine learned model(s) 840 to determine the existence of an anomaly, as described herein.

The machine learning computing system 830 can include one or more processors 832 and a memory 834. The one or more processors 832 can be any suitable processing device (e.g., a processor core, a microprocessor, an ASIC, a FPGA, a controller, a microcontroller, etc.) and can be one processor or a plurality of processors that are operatively connected. The memory 834 can include one or more non-transitory computer-readable storage media, such as RAM, ROM, EEPROM, EPROM, one or more memory devices, flash memory devices, etc., and combinations thereof.

The memory 834 can store information that can be accessed by the one or more processors 832. For instance, the memory 834 (e.g., one or more non-transitory computer-readable storage mediums, memory devices) can store data 836 that can be obtained, received, accessed, written, manipulated, created, and/or stored. In some implementations, the machine learning computing system 830 can obtain data from one or more memory devices that are remote from the machine learning computing system 830.

The memory 834 can also store computer-readable instructions 838 that can be executed by the one or more processors 832. The instructions 838 can be software written in any suitable programming language or can be implemented in hardware. Additionally, or alternatively, the instructions 838 can be executed in logically and/or virtually separate threads on processor(s) 832. The memory 834 can store the instructions 838 that when executed by the one or more processors 832 cause the one or more processors 832 to perform operations. The machine learning computing system 830 can include a communication system 839, including devices and/or functions similar to that described with respect to the vehicle computing system 102 and/or the operations computing system 106.

In some implementations, the machine learning computing system 830 can include one or more server computing devices. If the machine learning computing system 830 includes multiple server computing devices, such server computing devices can operate according to various computing architectures, including, for example, sequential computing architectures, parallel computing architectures, or some combination thereof.

In addition or alternatively to the model(s) 840 at the vehicle computing system 102 and/or the operations computing system 106, the machine learning computing system 830 can include one or more machine-learned models 850. As examples, the machine-learned models 850 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks, or other forms of neural networks. The machine-learned models 850 can be similar to and/or the same as the machine-learned models 840.

As an example, the machine learning computing system 830 can communicate with the vehicle computing system 102 and/or the operations computing system 106 according to a client-server relationship. For example, the machine learning computing system 830 can implement the machine-learned models 850 to provide a web service to the vehicle computing system 102 and/or the operations computing system 106. For example, the web service can provide machine-learned models to an entity associated with an autonomous vehicle; such that the entity can implement the machine-learned model (e.g., to determine anomalies within a surrounding environment of a vehicle, etc.). Thus, machine-learned models 850 can be located and used at the vehicle computing system 102 and/or the operations computing system 106 and/or machine-learned models 850 can be located and used at the machine learning computing system 830.

In some implementations, the machine learning computing system 830, the vehicle computing system 102, and/or the operations computing system 106 can train the machine-learned models 840 and/or 850 through use of a model trainer 860. The model trainer 860 can train the machine-learned models 840 and/or 850 using one or more training or learning algorithms. One example training technique is backwards propagation of errors. In some implementations, the model trainer 860 can perform supervised training techniques using a set of labeled training data. In other implementations, the model trainer 860 can perform unsupervised training techniques using a set of unlabeled training data. The model trainer 860 can perform a number of generalization techniques to improve the generalization capability of the models being trained. Generalization techniques include weight decays, dropouts, or other techniques.

In particular, the model trainer 860 can train a machine-learned model 840 and/or 850 based on a set of training data 862. The training data 862 can include, for example, a number of sets of data from previous events (e.g., previous event logs indicative anomalies). In some implementations, the training data 862 can include the training dataset 144. In some implementations, the training data 862 can include data indicative of anomalies determined using a rule(s)-based algorithm and/or one or more anomaly categories. In some implementations, the training data 862 can be taken from the same vehicle as that which utilizes that model 840/850. In this way, the models 840/850 can be trained to determine outputs (e.g., detecting anomalies) in a manner that is tailored to that particular vehicle. Additionally, or alternatively, the training data 862 can be taken from one or more different vehicles that that which is utilizing that model 840/850. The model trainer 860 can be implemented in hardware, firmware, and/or software controlling one or more processors.

The network(s) 880 can be any type of network or combination of networks that allows for communication between devices. In some embodiments, the network(s) 880 can include one or more of a local area network, wide area network, the Internet, secure network, cellular network, mesh network, peer-to-peer communication link and/or some combination thereof and can include any number of wired or wireless links. Communication over the network(s) 880 can be accomplished, for instance, via a network interface using any type of protocol, protection scheme, encoding, format, packaging, etc.

FIG. 8 illustrates one example system 800 that can be used to implement the present disclosure. Other computing systems can be used as well. For example, in some implementations, the vehicle computing system 102 and/or the operations computing system 106 can include the model trainer 860 and the training dataset 862. In such implementations, the machine-learned models 840 can be both trained and used locally at the vehicle computing system 102 and/or the operations computing system 106. As another example, in some implementations, the vehicle computing system 102 and/or the operations computing system 106 may not be connected to other computing systems.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for anomaly detection, comprising:
obtaining, by a computing system comprising one or more computing devices, state data indicative of one or more states of one or more objects that are within a surrounding environment of an autonomous vehicle;
determining, by the computing system, an existence of an anomaly within the surrounding environment of the autonomous vehicle based at least in part on the state data indicative of the one or more states of the one or more objects within the surrounding environment of the autonomous vehicle; and
determining, by the computing system, a motion plan for the autonomous vehicle based at least in part on the existence of the anomaly within the surrounding environment of the autonomous vehicle.

2. The computer-implemented method of claim 1, wherein the anomaly is associated with at least one object of the one or more objects within the surrounding environment, and wherein determining, by the computing system, the existence of the anomaly within the surrounding environment of the autonomous vehicle comprises:
determining, by the computing system, the existence of the anomaly associated with the at least one object within the surrounding environment of the autonomous vehicle based at least in part on state data indicative of one or more states of the at least one object within the surrounding environment of the autonomous vehicle.

3. The computer-implemented method of claim 2, wherein determining, by the computing system, the existence of the anomaly within the surrounding environment of the autonomous vehicle comprises:
determining, by the computing system, an actual motion trajectory of the at least one object and a predicted motion trajectory of the at least one object; and
determining, by the computing system, the existence of the anomaly based at least in part on a comparison of the actual motion trajectory of the at least one object and the predicted motion trajectory of the at least one object.

4. The computer-implemented method of claim 1, wherein the determining, by the computing system, the existence of the anomaly within the surrounding environment of the autonomous vehicle comprises:
obtaining, by the computing system, data indicative of a machine-learned anomaly detection model;
inputting, by the computing system, the state data indicative of the one or more states of the one or more objects into the machine-learned anomaly detection model; and
obtaining, by the computing system, an output from the machine-learned anomaly detection model, wherein the output is indicative of the existence of the anomaly within the surrounding environment of the autonomous vehicle.

5. The computer-implemented method of claim 4, wherein the output indicates that the anomaly is associated with at least one object of the one or more objects.

6. The computer-implemented method of claim 4, wherein the output indicates a likelihood that the anomaly exists.

7. The computer-implemented method of claim 1, wherein determining, by the computing system, the existence of the anomaly within the surrounding environment of the autonomous vehicle comprises:
determining, by the computing system, an actual motion trajectory of at least one object based at least in part on the state data indicative of the one or more states of the at least one object;
accessing, by the computing system, data indicative of one or more anomaly categories; and
determining, by the computing system, the existence of the anomaly based at least in part on the actual motion trajectory of the at least one object fitting into at least one of the one or more anomaly categories.

8. The computer-implemented method of claim 1, further comprising:
storing, by the computing system, data associated with the anomaly in a memory, wherein the data associated with the anomaly is included in a testing dataset used for testing a vehicle autonomy computing system.

9. The computer-implemented method of claim 1, wherein the one or more objects comprise a plurality of objects, and wherein the anomaly is associated with a scene of the surrounding environment, and wherein determining, by the computing system, the existence of the anomaly within the surrounding environment of the autonomous vehicle further comprises:
obtaining, by the computing system, data associated with the surrounding environment; and
determining, by the computing system, the existence of the anomaly associated with the scene of the surrounding environment of the autonomous vehicle based at least in part on state data indicative of one or more states of each of the plurality of objects within the surrounding environment of the autonomous vehicle and the data associated with the surrounding environment.

10. A computing system for anomaly detection, comprising:
one or more processors; and
one or more tangible, non-transitory, computer readable media that collectively store instructions that when executed by the one or more processors cause the computing system to perform operations, the operations comprising:
obtaining state data indicative of one or more states of one or more objects that are within a surrounding environment of an autonomous vehicle;
determining an existence of an anomaly within the surrounding environment of the autonomous vehicle based at least in part on the state data indicative of the one or more states of the one or more objects within the surrounding environment of the autonomous vehicle;
determining a motion plan for the autonomous vehicle based at least in part on the existence of the anomaly within the surrounding environment of the autonomous vehicle; and
causing the autonomous vehicle to initiate travel in accordance with the motion plan.

11. The computing system of claim 10, wherein determining the existence of the anomaly within the surrounding environment of the autonomous vehicle comprises:
determining an actual motion trajectory of at least one object of the one or more objects and a predicted motion trajectory of the at least one object; and
determining the existence of the anomaly based at least in part on the actual motion trajectory of the at least one object and the predicted motion trajectory of the at least one object.

12. The computing system of claim 10, wherein determining the existence of the anomaly within the surrounding environment of the autonomous vehicle comprises:
determining the existence of the anomaly within the surrounding environment of the autonomous vehicle based at least in part on a machine-learned anomaly detection model.

13. The computing system of claim 10, wherein determining the existence of the anomaly within the surrounding environment of the autonomous vehicle comprises:
determining the existence of the anomaly based at least in part on one or more anomaly categories.

14. The computing system of claim 10, wherein determining the motion plan for the autonomous vehicle based at least in part on the existence of the anomaly within the surrounding environment of the autonomous vehicle comprises:
generating data indicative of the existence of the anomaly; and
determining the motion plan for the autonomous vehicle based at least in part on the data indicative of the existence of the anomaly.

15. The computing system of claim 10, wherein the anomaly is associated with a scene of the surrounding environment.

16. The computing system of claim 10, wherein the object is a vehicle within the surrounding environment of the autonomous vehicle, and wherein the anomaly is associated with at least one of a u-turn maneuver of the vehicle or a parallel parking maneuver of the vehicle.

17. An autonomous vehicle comprising:
one or more processors; and
one or more tangible, non-transitory, computer readable media that collectively store instructions that when executed by the one or more processors cause the autonomous vehicle to perform operations, the operations comprising:
obtaining state data indicative of one or more states of one or more objects that are within a surrounding environment of an autonomous vehicle;
determining an existence of an anomaly within the surrounding environment of the autonomous vehicle based at least in part on the state data indicative of the one or more states of the one or more objects within the surrounding environment of the autonomous vehicle;
generating data indicative of the existence of the anomaly; and
determining a motion plan for the autonomous vehicle based at least in part on the data indicative of the existence of the anomaly.

18. The autonomous vehicle of claim 17, wherein determining the existence of the anomaly within the surrounding environment of the autonomous vehicle comprises:
determining the existence of the anomaly within the surrounding environment of the autonomous vehicle based at least in part on at least one of a rule-based algorithm, a machine-learned model, or one or more anomaly categories.

19. The autonomous vehicle of claim 17, wherein the operations further comprise:
providing, for inclusion in a data set stored in a memory, at least one of the data indicative of the anomaly or the state data indicative of the one or more states of the one or more objects.

20. The autonomous vehicle of claim 17, wherein the anomaly is associated with an at least one object of the one or more object or a scene of the surrounding environment.
